(19) United States
(12) Patent Application Publication
(10) Pub. No.: US 2011/0210998 A1
(43) Pub. Date: Sep. 1, 2011

(54) INKJET PRINTING APPARATUS AND INKJET PRINTING METHOD

(75) Inventors: Takumi Kaneko, Tokyo (JP); Rie Takekoshi, Kawasaki-shi (JP)

(73) Assignee: CANON KABUSHIKI KAISHA, Tokyo (JP)

(21) Appl. No.: 13/030,788

(22) Filed: Feb. 18, 2011

(30) Foreign Application Priority Data
Feb. 26, 2010 (JP) 2010-042704

(51) Int. Cl. B41J 29/38; B41J 2/015

(52) U.S. Cl. 347/9; 347/21

(57) ABSTRACT

An ink jet printing apparatus and ink jet printing method are provided that are capable of implementing an overcoating in which an interference color of a particular wavelength is not generated, without consuming more clear ink than necessary to overcoat the image. For this, a first application step is provided that prints clear ink during the printing of the image on the print medium using color ink, or after the printing step has been completed, and after taking time for the applied clear ink to fix, a second application step is provided that prints clear ink again. Accordingly, raised portions are formed by the clear ink drops applied at the second application step, on the uniform layer of clear ink formed at the first application step, and it is possible to cause light of various wavelengths (colors) to be included in the light reflected off of the print object.

### BACKGROUND OF THE INVENTION

1. Field of the Invention

The present invention relates to an ink jet printing apparatus and an ink jet printing method that form an image on a print medium using color ink for printing an image and clear ink for protecting the image.

2. Description of the Related Art

Ink jet printing apparatuses have a variety of advantages such as performing high density, high speed printing operations, low running costs and quiet printing, and are commercialized in a variety of forms as output devices for devices of all types and as portable printers, for example.

There has been an increasing demand for ink jet printing apparatuses that output images with improved visual quality and weather resistance, and many apparatuses that print images using pigment ink have been provided recently. A technique for increasing image glossiness and resistance to scratching (hereinafter, “scratch resistance”) by applying clear ink on top of an image formed by color ink, such as pigment ink for example, that is, by overcoating the image surface, is disclosed in Japanese Patent Laid-Open No. 2005-081754.

Nevertheless, in printed objects obtained after overcoating clear ink on an image, colors unrelated to the image are generated by light interference at the clear ink layer, which often deteriorates image quality.

FIG. 1 is a schematic cross sectional diagram of the print medium layers wherein clear ink is applied on an image printed by pigment ink. A pigment layer 1002 is formed on the print medium 1001 by the printing of pigment ink, and a clear ink layer 1003 is formed on top of it. In general, the clear ink layer 1003 has a thickness d roughly on the order of 100 nm to 500 nm.

Parallel light from, for example, sunlight or a fluorescent lamp, is split into reflected light 1005, which is reflected at the top of the clear ink layer 1003, and light 1006 which has passed through the clear ink layer 1003 and is reflected at the surface of the pigment layer 1002, and light interference is produced according to the optical path difference between them. When the intensity of light having a wavelength satisfying the equation m×λ=n×2d×cos θ+λ/2 (m is an integer) (equation 1), where θ is angle of incidence, λ is the wavelength of the incident light and n is the index of refraction of the clear ink layer 1003, is increased, the interference color of that light becomes strongly perceptible in comparison to other colors. Also, because the wavelength λ satisfying the above equation changes according to the thickness d of the clear ink layer 1003, when the thickness of the ink layer 1003 is not uniform there are also cases where rainbow-colored reflected light is recognizable. This type of generation of colors that are unrelated to the image degrade the quality of the printed object.

In general it is thought that the following three methods can be used to suppress damage caused by the above described interference. (1) Making the thickness d of the clear ink layer extremely thin. (2) Making the thickness d of the clear ink layer thick to the extent where interference is caused at many visible wavelengths. (3) Forming portions where the clear ink layer is thick and portions where the clear ink layer is thin, generating various interference wavelengths.

However, concerning (1), when the clear ink layer is made extremely thin the original purposes of applying a clear ink layer, that is, glossiness and scratch resistance on the image surface, are not obtained. Also, concerning (1), a thickness on the order of 1 μm is necessary for the clear ink layer to be thick enough that a particular interference color does not stand out, but in this case a large volume of clear ink is consumed in comparison to the color ink. It is not preferable to invite an increase size or cost of apparatus because of clear ink, which does not have a direct relation to the image.

On the other hand, concerning (3), it is necessary to change the application amount of clear ink according to location, in order to form portions where the thickness of the clear ink is thick and portions where the thickness of the clear ink is thin. In this case, if the clear ink printing ratios are biased according to location, as in FIG. 14, the printed clear ink drops 212 spread on the print medium surface as in FIG. 16A, and it is possible to create a clear ink layer 213 of a variant thickness as shown in FIG. 16B. However, in order to create a sufficient difference in thickness a large amount of clear ink is consumed, and because the level change created by this method is gradual, and can be achieved only with a large period, it is difficult to sufficiently cause interference colors not to stand out.

### SUMMARY OF THE INVENTION

The present invention was formed in light of the problems caused by the aforementioned techniques of the prior art. Accordingly it is an object to provide an ink jet printing apparatus and ink jet printing method that are capable of implementing an overcoating in which an interference color of a particular wavelength is not generated, without consuming more clear ink than necessary to overcoat the image.

In a first aspect of the present invention, there is provided an ink jet printing method comprising: a printing step wherein an image is printed on a unit area of the print medium by application of color ink containing color material from an application unit; a first application step wherein clear ink not containing color material is applied by the application unit onto the unit area during the printing step or after the printing step is completed; and a second application step which is performed after the first application step has been completed, wherein the clear ink is applied at the unit area by the application unit, after taking time for the fixation of the clear ink applied at the first application step.

In a second aspect of the present invention, there is provided an ink jet printing apparatus comprising: an application unit capable of applying color ink containing color material and clear ink not containing color material; a control unit configured to control the application unit; wherein the control unit controls the application unit such that an image is printed on a unit area of the print medium by the application of the color ink from the application unit, the clear ink is applied on the unit area during the application of the color ink or after the completion of the application of the color ink by the application unit, and after the application of clear ink has been completed and after taking fixation time for the fixation of the applied clear ink, the clear ink is applied at the unit area again.

Further features of the present invention will become apparent from the following description of exemplary embodiments (with reference to the attached drawings).

### BRIEF DESCRIPTION OF THE DRAWINGS

FIG. 1 is a cross sectional diagram of the print medium layers wherein clear ink is applied on pigment ink;

FIG. 2 is a diagram of the general configuration of an ink jet printing apparatus capable of being used in the present invention;

FIG. 3 is a block diagram for explaining the control structure of the ink jet printing apparatus;

FIG. 4 is a schematic diagram of the ejection port surface of the print head used in the first embodiment;

FIG. 5 is a figure that shows a result observed between clear ink print ratio and interference color;

FIGS. 6A to 6F are figures that show the timing of the printing of clear ink and the fixation state on the print medium;

FIG. 7 is a schematic diagram for simply explaining a multi-pass printing method;

FIGS. 8A to 8C are figures that show the printing aspects of an 8-pass multi-pass printing;

FIG. 9 is a figure that illustrates mask patterns applied to color ink ejection port arrays;

FIG. 10 is a figure that illustrates mask patterns applied to a clear ink ejection port;

FIGS. 11A to 11H are cross sectional views for explaining the application of ink by a multi-pass printing;

FIGS. 12A to 12E are schematic top views for explaining a printing state;

FIGS. 13A to 13E are cross sectional views that show the printing state at a unit area where image data does not exist;

FIG. 14 is a figure to explain a method of biasing clear ink printing ratios according to location;

FIG. 15 is a figure that shows a result of comparing the printing of an object by prior art methods in comparison to the method of the present invention;

FIGS. 16A and 16B are diagrams that show printing aspects in a case where clear ink printing ratios are biased;

FIG. 17 is a schematic diagram of the ejection port surface of the print head used in the second embodiment;

FIG. 18 is a cross sectional diagram that explains the printing aspects of the 1st application step at a low gradation area;

FIG. 19 is a schematic diagram of the ejection port surface of the print head used in the third embodiment; and

FIG. 20 is a flowchart that shows steps executed by the system controller of the third embodiment.

### DESCRIPTION OF THE EMBODIMENTS

Embodiments of the present invention will be described in detail below.

### First Embodiment

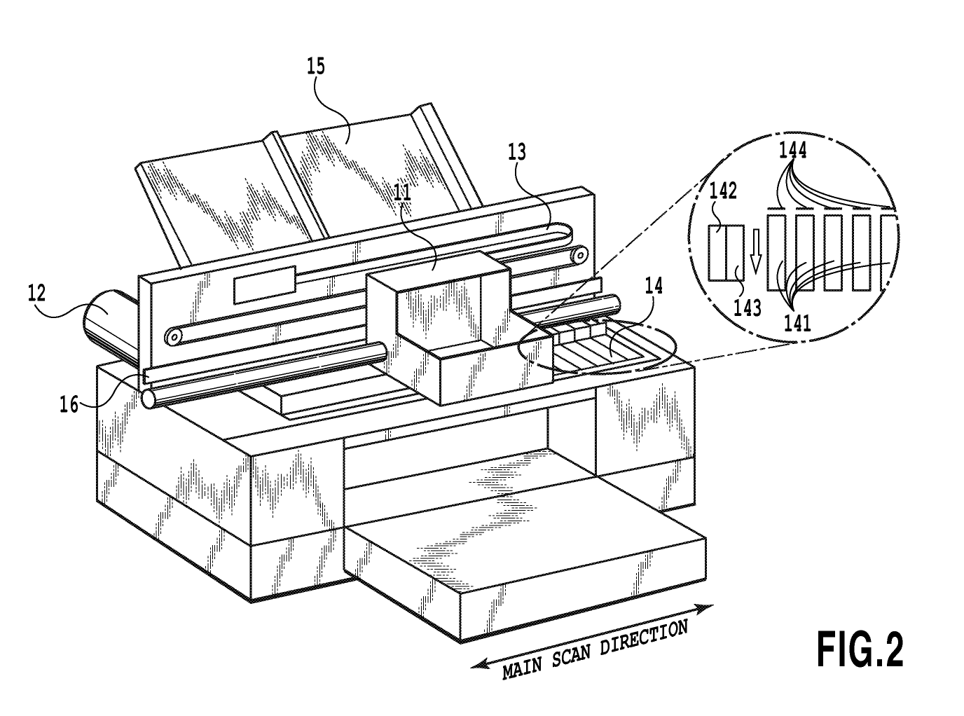

FIG. 2 is a diagram for explaining the general configuration of the ink jet printing apparatus used in the present embodiment. The carriage 11, which mounts an ink jet print head and a plurality of color ink tanks, moves back and forth in the main scan direction, with the carriage motor 12 acting as a drive source. The flexible cable 13, which is attached such as to follow the back and forth scanning of the carriage 11, carries out the transmission and reception of electrical signals between the print head mounted on the carriage 11 and a control unit (not shown). The mobile position of the carriage 11 can be detected by way of an encoder sensor, which is provided on the carriage and optically reads an encoder 16 extendedly attached along the main scan direction.

When a print operation command is input by the externally connected host computer, one sheet of the print media stacked in the feed tray 15 is fed to a position where printing by the print head mounted on the carriage 11 is possible. Subsequently, an image is formed gradually on the print medium by alternately repeating main print scans of the print head while ejecting ink, according to print signals, and fixed-distance conveyances of the print medium in a direction different than the main scan direction.

A recovery device 14 for executing print head maintenance operations is provided at the end of the region in which the carriage 11 moves. The recovery device 14 is provided, for example, with caps 141 for protecting the ejection port surface of the print head during suction or nonuse, an ejection receptacle 142 for catching clear ink during ejection recovery, and an ejection receptacle 143 for catching color ink ejected during ejection recovery. The wiper blade 144 wipes the ejection port surface of the print head while moving in the direction of the arrow.

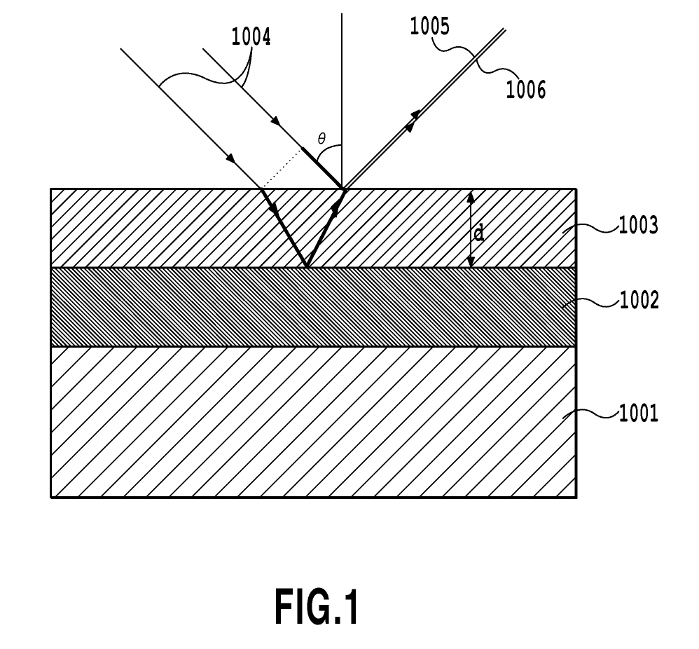

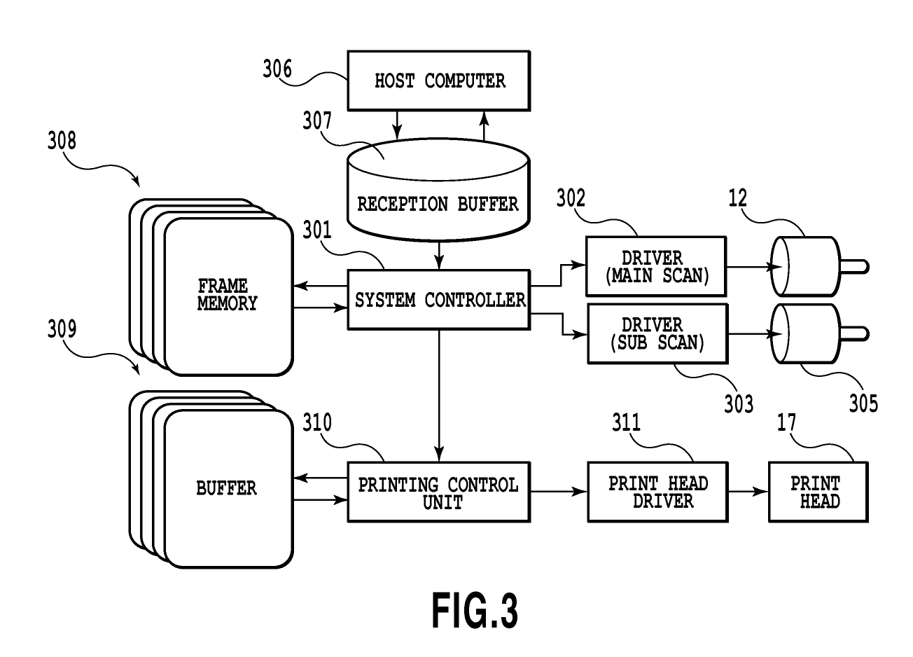

FIG. 3 is a block diagram for explaining the control structure of the ink jet printing apparatus illustrated in FIG. 1. 301 is a system controller that processes received image data and controls the entire device. In addition to a microprocessor, a memory element (ROM) that stores control programs, later described mask patterns, a RAM that serves as a work area when executing all sorts of image processes, and the like, are arranged inside the system controller 301. 12 is a carriage motor for moving the carriage 11 in the main scanning direction and 305 is a conveyance motor for conveying print media in the sub-scanning direction. 302 and 303 are drivers, and they receive, from the system controller 301, information such as the travelling speed and distance of the print head and print medium, and they drive the respective motors 12 and 305.

306 is an externally connected host computer that forwards image information to be printed, to the ink jet printing apparatus of the present embodiment. The form of the host computer 306 may take the shape of a computer serving as an information processing apparatus or the shape of an image reader. 307 is a reception buffer that temporarily stores data from the host computer 306, and accumulates received data until it is read by the system controller 303.

308 is frame memory for developing data to be printed into image data, and has a memory size, for each ink color, of a capacity sufficient for printing. 309 is a buffer for temporarily storing respective data of each ink color to be printed, and its printing capacity varies in accordance with the number of print head ejection ports.

310 is a printing control unit that, for example, appropriately controls the print head 17 according to commands from the system controller 301 and controls, for example, print speed and the amount of print data. 311 is a print head driver that is controlled by signals from the printing control unit 310 and drives the print head 17, causing ink to be ejected.

In the above configuration, image data supplied from the host computer 306 is forwarded to the reception buffer 307 where it is temporarily stored, and developed into a frame memory 308 provided for each ink color by the system controller 301. Next, the developed image data is read out by the system controller 301, and after prescribed image processing is applied, developed into the buffer 309, for each color. The printing control unit 310 controls the actions of the print head 17 based on image data within each buffer.

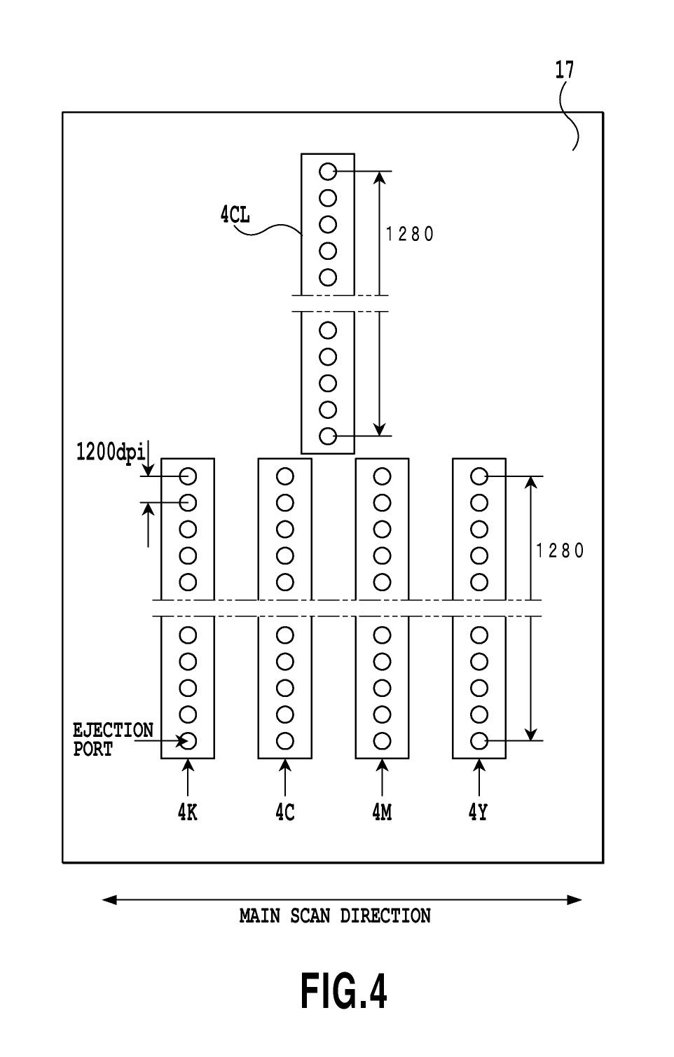

FIG. 4 is a schematic diagram that illustrates the configuration of the ejection port surface of the print head 17 used in the present embodiment. Ejection port arrays of 1 color, consisting of 1280 ejection ports aligned in the sub-scanning direction at a density of 1200 dots per inch, are formed on the print head 17, and only a number of arrays corresponding to the ink colors are plurally aligned in the main scanning direction. In the present embodiment an ejection port array 4K that ejects black ink, an ejection port array 4C that ejects cyan ink, an ejection port array 4M that ejects magenta ink and an ejection port array 4Y that ejects yellow ink are lined up in the order of the figure. An ejection port array 4CL that ejects clear ink is also arranged on the downstream side of the sub-scanning direction, with respect to the 4 color ejection port arrays. The liquid drops ejected from each of the ejection ports are approximately 4.5 pl but the ejection volume of the black ink may be set higher than the others in order to achieve high density black images. The printing apparatus of the present embodiment is capable of printing dots at a printing density of 2400 dpi (dots/inch) in the main scanning direction and 1200 dpi in the sub-scanning direction by way of ejecting while scanning such print head 17 in the main scanning direction.

The composition of the ink set and the purification method applied in the present embodiment will now be explained. In the present embodiment 4 colors of pigment ink, which contain pigment, are used as the color ink.

### <Yellow Ink>

### (1) Manufacture of Dispersion Fluid

First, 10 parts of the pigment shown below, 30 parts of an anionic macromolecule and 60 parts purified water are mixed.
Pigment: [C.I. Pigment Yellow 74 (Product Name: Hansa Brilliant Yellow 5GX (Manufactured by Clariant))]
Anionic Macromolecule P1: [styrene/butyl acrylate/acrylic acid copolymer (copolymerization ratio (ratio by weight)=30/40/30), acid value 202, weight-average molecular weight 6500, 10% solid content aqueous solution. Neutralizing agent: potassium hydrate] 30 parts.

Next, the materials shown above are stocked into a batch type vertical sand-mill (manufactured by Imex), 150 parts of 0.3 mm diameter zirconia beads are filled in, and a dispersion process is carried out while water cooling. Additionally the dispersed liquid is centrifuged and coarse particles are removed. Next, a pigment dispersion element with a solid content of roughly 12.5% and a weighted average grain diameter of 120 nm are obtained as the final manufactured good. Using the obtained pigment dispersion element, ink is manufactured in the manner described below.

### (2) Ink Manufacture

The materials below are mixed, sufficiently agitated, and after dissolution and dispersion, pressure filtered in a micro-filter having a pore size of 1.0 μm (manufactured by Fuji Film), and ink 1 is prepared.

| | | |
|---|---|---|
| The pigment dispersion element 1 described | 40 | parts |
| above | | |
| glycerin | 9 | parts |
| ethylene glycol | 6 | parts |
| acetylene glycol ethylene oxide additive | 1 | part |
| (Article Name: Acetylenol EH) | | |
| 1,2-hexanediol | 3 | parts |
| polyethylene glycol (molecular weight 1000) | 4 | parts |
| water | 37 | parts |

### <Magenta Ink>

### (1) Manufacture of Dispersion Fluid

First, with benzyl acrylate and methacrylic acid as raw materials, an AB type block polymer, with an acid value of 300 and a number average molecular weight of 2500, is made by the usual method, neutralized by a potassium hydrate aqueous solution, diluted by ion-exchanged water, and a homogenous 50% mass polymer aqueous solution is produced. Also, 100 g of the above polymer solution is mixed with 100 g C.I. pigment red 122 and 300 g of ion-exchanged water, and mechanically agitated for 0.5 hours. Next, using a micro-fluidizer, this mixture is processed by passing it into an interaction chamber at a liquid pressure below roughly 70 MPa for five times. Additionally, the above obtained dispersed liquid is centrifuged (at 12,000 rpm for 20 minutes), removing the undispersed material containing coarse particles, and magenta dispersion fluid is obtained. The pigment density of the obtained magenta dispersion fluid is 10% by weight and the dispersant density is 5% by weight.

### (2) Ink Manufacture

The above magenta dispersion fluid is used in the manufacture of ink. The materials below are added making it a prescribed density, and after these materials are sufficiently mixed and agitated, they are pressure filtered in a micro-filter having a pore size of 2.5 μm (manufactured by Fuji Film), and pigment ink is prepared, having a pigment density of 4% by weight and a dispersant density of 2% by weight.

| | |
|---|---|
| The above magenta dispersion fluid | 40 parts |
| glycerin | 10 parts |
| diethylene glycol | 10 parts |
| acetylene glycol EO additive | 0.5 parts |
| ion-exchanged water (Made by Kawaken Fine | 39.5 parts |
| Chemicals) | |

<Cyan Ink>

### (1) Manufacture of Dispersion Fluid

First, with benzyl acrylate and methacrylic acid as raw materials, an AB type block polymer, with an acid value of 250 and a number average molecular weight of 3000, is made by the usual method, neutralized by a potassium hydrate aqueous solution, diluted by ion-exchanged water, and a homogenous 50% mass polymer aqueous solution is produced. Also, 180 g of the above polymer solution is mixed with 100 g C.I. pigment blue 15:3 and 220 g of ion-exchanged water, and mechanically agitated for 0.5 hours. Next, using a micro-fluidizer, this mixture is processed by passing it into an interaction chamber at a liquid pressure below roughly 70 MPa for five times. Additionally, the above obtained dispersed liquid is centrifuged (at 12,000 rpm for 20 minutes), removing the undispersed material containing coarse particles, and cyan dispersion fluid is obtained. The pigment density of the obtained cyan dispersion fluid is 10% by weight and the dispersant density is 10% by weight.

### (2) Ink Manufacture

The above cyan dispersion fluid is used in the manufacture of ink. The materials below are added making it a prescribed density, and after these materials are sufficiently mixed and agitated, they are pressure filtered in a micro-filter having a pore size of 2.5 μm (manufactured by Fuji Film), and pigment ink is prepared, having a pigment density of 2% by weight and a dispersant density of 2% by weight.

| | |
|---|---|
| The above cyan dispersion fluid | 20 parts |
| glycerin | 10 parts |
| diethylene glycol | 10 parts |
| acetylene glycol EO additive | 0.5 parts |
| ion-exchanged water (Made by Kawaken Fine | 53.5 parts |
| Chemicals) | |

### <Black Ink>

### (1) Manufacture of Dispersion Fluid

100 g of the polymer solution used in the yellow ink is mixed with 100 g of carbon black and 300 g of ion-exchanged water, and mechanically agitated for 0.5 hours. Next, using a micro-fluidizer, this mixture is processed by passing it into an interaction chamber at a liquid pressure below roughly 70 Mpa for five times. Additionally, the above obtained dispersed liquid is centrifuged (at 12,000 rpm for 20 minutes), removing the undispersed material containing coarse particles, and black dispersion fluid is obtained. The pigment density of the obtained black dispersion fluid is 10% by weight and the dispersant density is 6% by weight.

### (2) Ink Manufacture

The above black dispersion fluid is used in the manufacture of ink. The materials below are added, making it a prescribed density, and after these materials are sufficiently mixed and agitated, they are pressure filtered in a micro-filter having a pore size of 2.5 μm (manufactured by Fuji Film), and pigment ink is prepared, having a pigment density of 5% by weight and a dispersant density of 3% by weight.

| | |
|---|---|
| The above black dispersion fluid | 50 parts |
| glycerin | 10 parts |
| triethylene glycol | 10 parts |
| acetylene glycol EO additive | 0.5 parts |
| ion-exchanged water (Made by Kawaken Fine | 25.5 parts |
| Chemicals) | |

<Clear Ink>

### (1) Manufacture of Resin Solution

First, resin aqueous solution is obtained in the following manner. 15% by weight of a resin composed of styrene and acrylic acid, and an amount of potassium hydrate chemically equivalent to the carbolic acid composing the acrylic acid are added, and after the remainder is adjusted to 100% by weight by water, it is agitated at 80° C. and the resin is dissolved. After that, it is adjusted with water such that the contained amount of solid contents becomes 15% by weight, and the resin aqueous solution is obtained. The resin has a weight-average molecular weight of 7000.

### (2) Ink Manufacture

Each of the components shown below are mixed, and after sufficient agitation, ink is manufactured. The obtained clear ink was colorless and transparent.

| | | |
|---|---|---|
| resin aqueous solution | 26.6 | parts |
| glycerin | 9 | parts |
| ethylene glycol | 6 | parts |
| acetylene glycol EO additive | 1 | part |
| ion-exchanged water ( Made by Kawaken Fine | 57.4 | parts |
| Chemicals) | | |

Because the surface tension of the clear ink of the present embodiment, manufactured as above, is low, it spreads easily on a print medium. Also, even 2 liquid drops that are printed at spaced positions will become mutually connected if they touch before fixing, and has a characteristic wherein a uniform layer is formed easily.

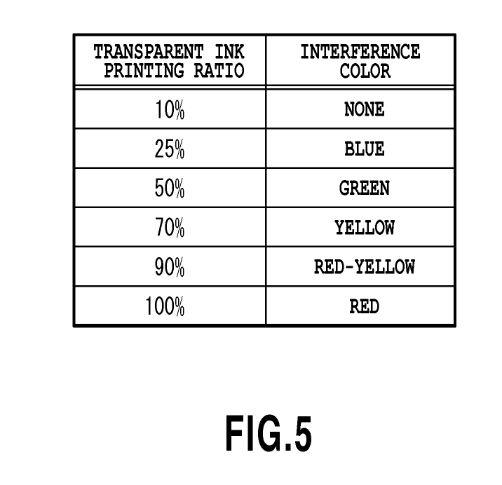

FIG. 5 is a figure that shows clear ink print ratio and observed interference color results in the case where the present inventors printed an image using the printing apparatus, print head and ink described above. In the present investigation, after the above described cyan ink was printed on Canon glossy photo paper (LFM-GP421R) at a printing ratio of 150%, clear ink was printed at the respective print ratios. 8-pass multi-pass printing was performed. Printing ratio denotes the proportion of pixels where ink drops are printed (applied), among all of the pixels included in a unit area where printing is possible at a resolution of 2400 dpi×1200 dpi. As described above, because the surface tension of the clear ink used in the present embodiment is low, a uniform layer of clear ink will be formed at a print density on the order of 25% where the resolution is 2400 dpi×1200 dpi and the ejection volume is 4.5 pl. The figure shows visual confirming resultants of interference color of the output that is printed in this manner.

As can be understood from the figure, in the case where the printing ratio of clear ink is low (lower than 10%), the interference color can not be seen. This is because the uniform layer is not formed, because the dots are dispersed. Or conceivably, this is because, even where the layer has been formed, the wavelength region satisfying equation 1 does not reside in the visible region because it is an ultrathin layer.

When the printing ratio turns to the order of 25% the stabilized clear ink layer is formed and the interfering light can be perceived. Thus, as the clear ink printing ratio, that is, the thickness of the clear ink layer, gradually increases, the long wavelength (λ) interference color becomes perceivable.

Therefore, based on the above result, the present inventors draw attention to the fact that, if the thickness of the clear ink layer is not held and unevenness is made on the image surface, light of various wavelengths (colors) will be included in the reflected light, and a particular interference color can not be easy to notice. In order to accomplish this it has been found that regulation of the timing of the application of the clear ink is effective.

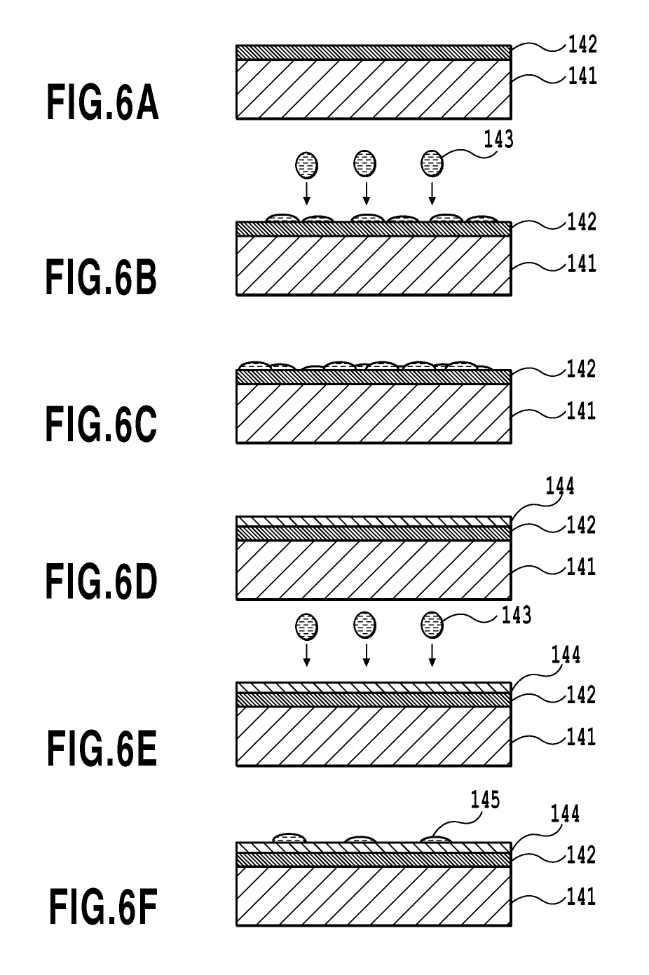

FIGS. 6A to 6F are figures for explaining the timing of the application (printing) of clear ink and the fixation state on the print medium in the present embodiment. FIG. 6A shows the first state where a color ink layer 142 has been formed on the print medium by the ejection port arrays 4Y to 4K of the print head 17. Next, a layer of clear ink is gradually formed by a multi-pass printing using the clear ink ejection port array 40L.

FIGS. 6B and 6C illustrate the first application step of clear ink. At the first application step, clear ink drops 143 are printed at a density of a degree by which adjacent clear ink drops that have landed on the print medium 141 contact each other. As described above, because the surface tension of the clear ink is low, it easily spreads out uniformly on the surface of the print medium when printing at a high density in this manner, and a ink layer 144 of FIG. 6B forms quickly.

In the present embodiment, a period of time is taken after the uniform clear ink layer (liquid layer) 144 is formed by this first application step. Next, after the clear ink layer 144 has fixed to a degree, a second application step is newly executed, as shown in FIG. 6E. At the second application step adjacent clear ink drops are printed at a low density of a degree by which they do not contact each other. The clear ink drops 145 printed at a low density in this manner do not spread widely on the print medium surface, and as shown in FIG. 6, are fixed in a separated state.

The thickness of the clear ink layer shown in FIG. 6F, formed by the first application step and the second application step, is uneven due to locations, at the second application step, where clear ink has been applied and locations where it has not been applied, which forms unevenness on the surface of the print medium. Because of this, when the printed image is viewed, it is possible for various wavelengths (colors) of light to be included in the reflected light, and it is possible to create printed output where a particular interference color can not be visually perceived.

In the present embodiment, 8-pass multi-pass printing is performed by the print head shown in FIG. 4 in order to execute the printing shown in FIGS. 6A to 6F. Multi-pass printing is explained simply below.

In a multi-pass printing, image data that the print head can print in 1 main scan is culled according to a mask pattern that has been prepared in advance, and an image is completed in phases by multiple main scans.

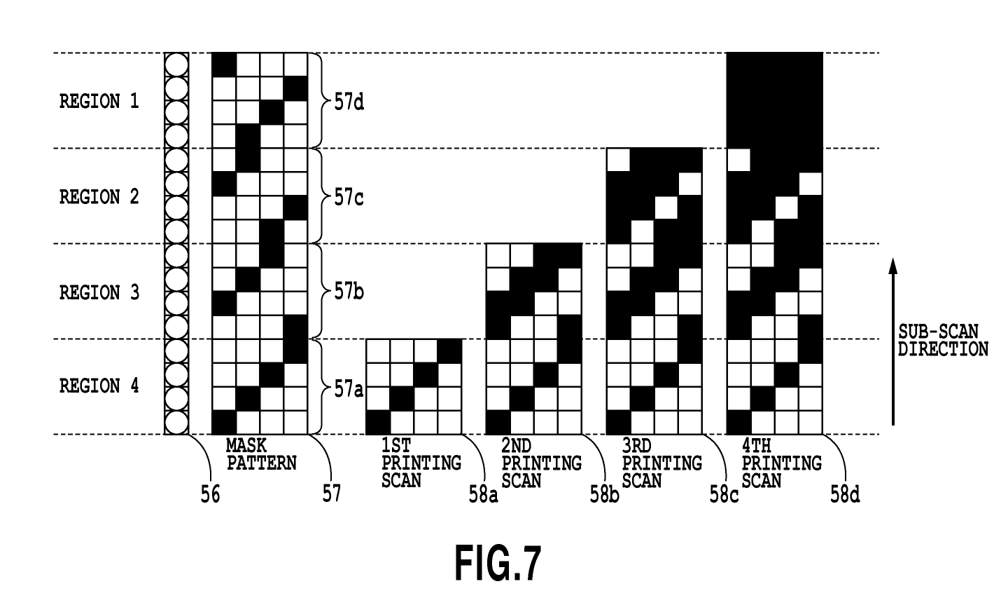

FIG. 7 is a schematic diagram for simply explaining a multi-pass printing method. Here, for the sake of simplicity, a case where a 4-pass multi-pass printing is carried out, employing an ejection port array 56 having 16 ejection ports, is explained. In the case of a 4-pass multi-pass printing, it is possible to think of the ejection port array 56 as being partitioned into 4 regions (1 to 4), each having 4 ejection ports.

57a to 57d illustrate the mask patterns respectively allocated to regions 1 to 4. Each of the mask patterns 57a to 57d have 4 pixel by 4 pixel areas with determined print-permitted pixels shown in black and non print-permitted pixels shown in white, and when these mask patterns 57a to 57d are superimposed the print-permitted pixels complemented each other. When printing is carried out in practice, a logical AND operation is carried out between the image data (print/non-print data) accorded to the individual ejection ports and the mask pattern, and an ejection operation is executed based on the result thereof. It should be noted that even though, for the sake of simplicity, mask patterns having a 4 pixel×4 pixel area have been illustrated, actual mask patterns have a considerably larger area in both the main scanning direction and the sub-scanning direction.

58a to 58d illustrate the case where an image is completed on a print medium by repeating print scans. In each print scan, regions 1 to 4 of the ejection port array 56 carry about printing only with respect to pixels that are print-permitted according to the mask patterns 57a to 57d, and when each print scan is completed the print medium is conveyed a distance corresponding to the width of each of the regions in the sub-scanning direction. By this configuration an image of unit area of the print medium (an area of the print medium corresponding to the width of each region of the ejection port array) is completed by 4 print scans.

If this type of multi-pass printing is carried out, variation particular to a nozzle (ejection port) and variance due to imprecision in the conveyance of the print medium are dispersed because each unit area of the print medium is printed by multiple scans and multiple regions of the ejection port array, and it is thus possible to reduce density unevenness and stripes.

In FIG. 7, for simplification, an example of a 4-pass multi-pass printing was explained, however, as in the present embodiment, in the case where an 8-pass multi-pass printing is carried out, 1 ejection port array may be partitioned into 8 regions and mask patterns may be accorded, the areas of which have a complementary relationship with respect to each other. In these types of mask patterns, if the complementary relationship between each of the areas is maintained, the arrangement of the print permitted areas may be respectively changed. For example, as in the present embodiment, in the case where multiple ejection port arrays are provided according to ink type, it is also possible to differ the mask patterns according to ink type.

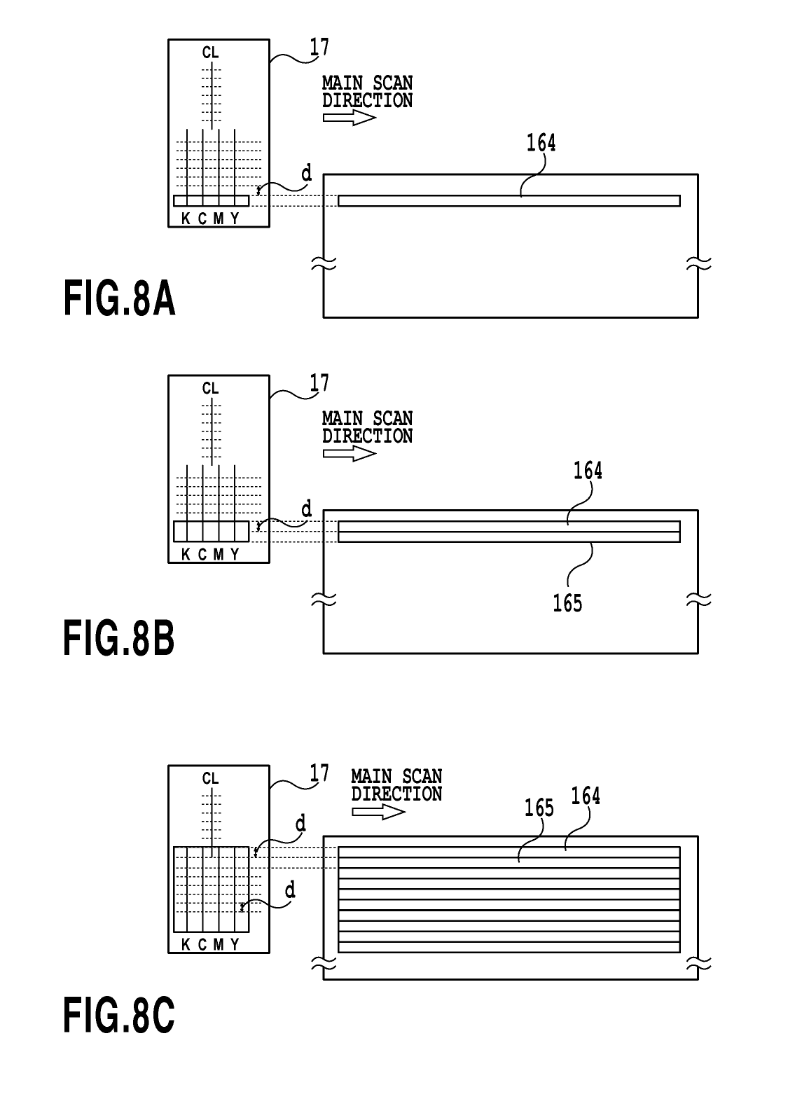

FIGS. 8A to 8C are figures for explaining printing on the print medium in the case where an 8-pass multi-pass printing is carried out using the print head of the present embodiment shown in FIG. 4. FIG. 8A illustrates a state where the 1st print scan pass is carried out on the unit area 164 having a width d, by color ink KCMY. FIG. 8B shows the state in which, after the print scan shown in FIG. 8A and a conveyance operation of the width d have been carried out, the 2nd print scan pass is carried out at the unit area 164 and the 1st print scan pass is carried out at the adjacent unit area 165. By repeating the above print scans, and by sequentially carrying out printing at subsequent unit areas, the image is completed as print scanning proceeds to each of the individual unit areas.

FIG. 8C shows the state where the 9th printing pass has been carried out at the unit area 164, on which the 8th printing scan pass has been carried out and printing by color ink has been 100% completed. In this manner clear ink is gradually printed at each unit area at print scan passes 9 to 16.

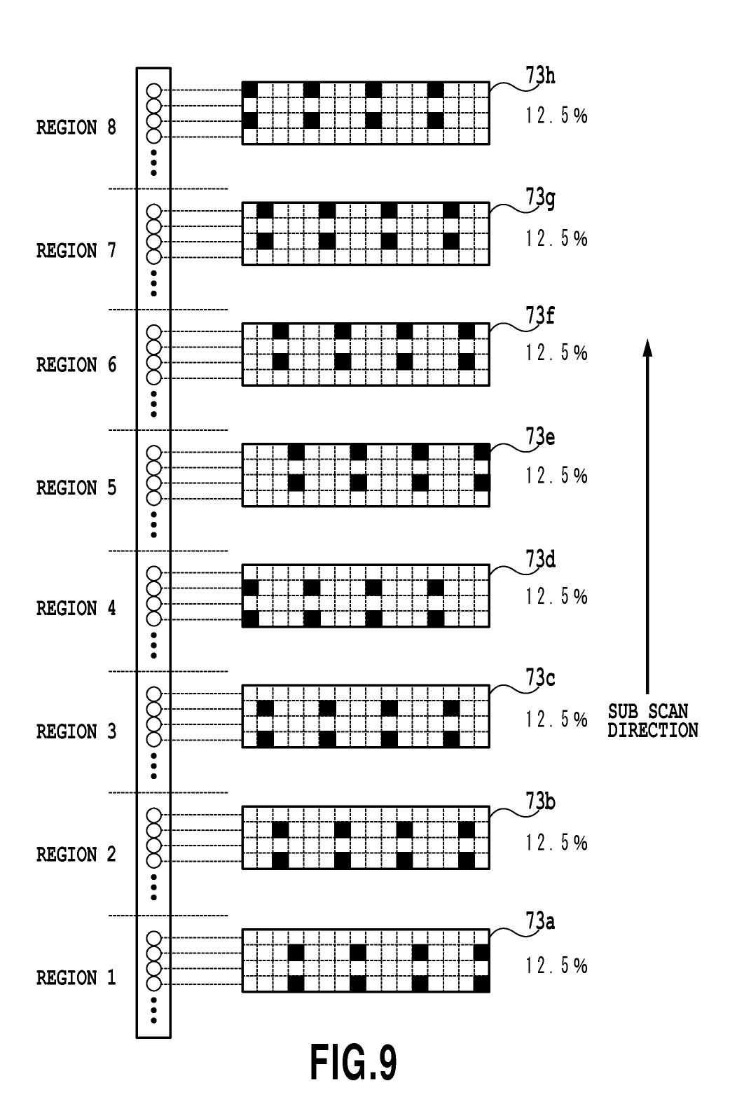

FIG. 9 is a figure that illustrates mask patterns applied to the color ink ejection port arrays 4Y to 4K of the present embodiment. In the present embodiment, because an 8-pass multi-pass printing is carried out, 1 ejection port array having 1280 ejection ports is partitioned into regions 1 to 8, with each region including 160 ejection ports. Here, mask patterns 73a to 73h are allocated, each with an area being 16 pixels in the main scanning direction and 4 pixels in the sub-scanning direction, and these 8 mask patterns 73a to 73h have a complementary relationship with respect to each other. Also, the print permission ratios (the ratio of print permitted pixels included in the 16 pixel by 4 pixel area) of each of the mask patterns are uniformly 12.5%. That is, according to the present embodiment, printing of color ink at a unit area is completed (100%) by 8 print scans of 12.5% each.

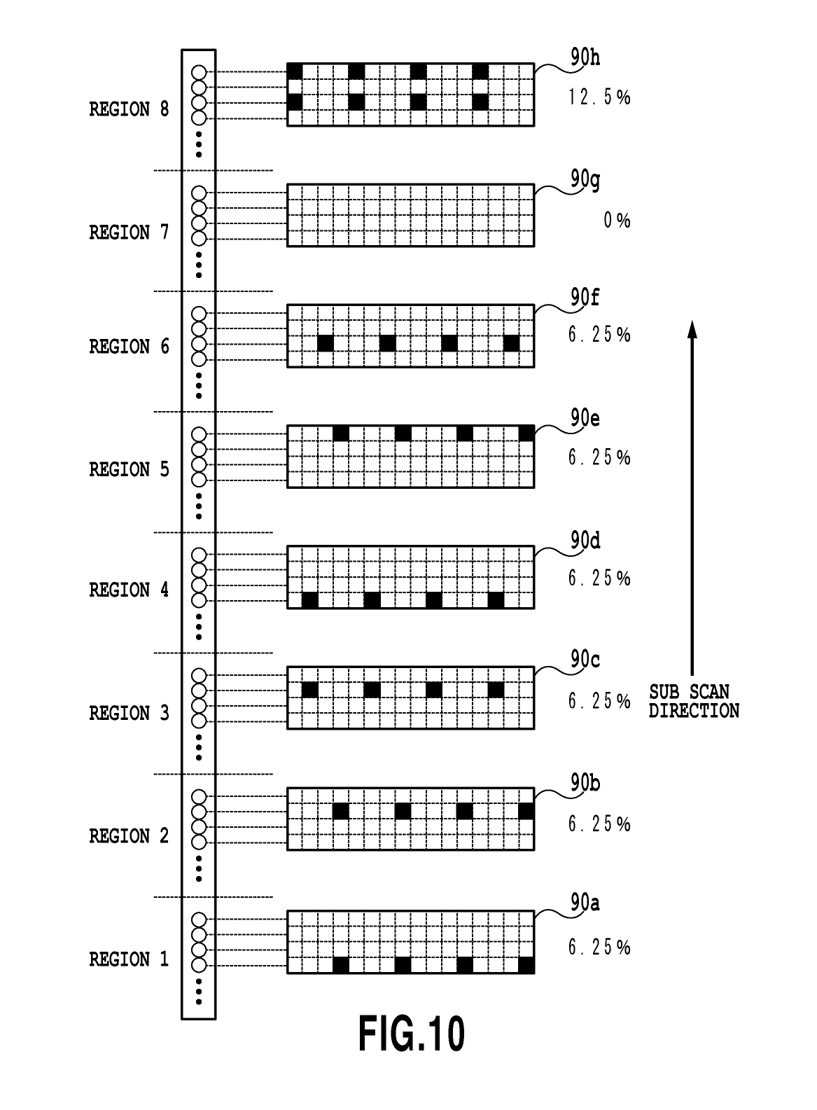

On the other hand, FIG. 10 is a figure that illustrates mask patterns applied to the clear ink ejection port 4CL of the present embodiment. Also, with respect to the clear ink, the ejection port 4CL is partitioned into regions 1 to 8 that each include 160 ejection ports, and mask patterns 90a to 90h are allocated to them respectively. The print ratio of the clear ink mask patterns amount to 50% even if summed and do not have a complementary relationship. This is because in the printing apparatus of the present embodiment, a uniform layer of clear ink is formed, as described above, at a print density on the order of 25%, and for the purpose of obtaining sufficient gloss and protection a printing ratio on the order of 50% is sufficient.

With respect to the clear ink, the print permission ratios at each of the regions are not the same, rather, regions 90a to 90f are 6.25%, region 90g is 0% and region h is 12.5%. However, there is no image data for clear ink and any print permitted pixel will be printed of one drop of clear ink. Therefore, printing of clear ink is carried out with respect to all of the print-permitted pixels shown in black, that is, printing is carried out at a printing ratio of 50% in respect to the entire image area.

In the case of carrying out 8-pass multi-pass printing using the above described mask patterns, at a unit area, color ink is printed at passes 1 to 8 at a rate of 12.5%, and clear ink is printed at passes 9 to 14 at a rate of 6.25 percent. After that, at pass 15 no ink is printed, and 12.5% of clear ink is printed at pass 16. Accordingly, in the case of the present embodiment, the printing at passes 9 to 14 becomes the 1st clear ink application step, and the printing of the 16th pass coming after the 15th pass, where the printing of clear ink is not carried out, becomes the 2nd application step.

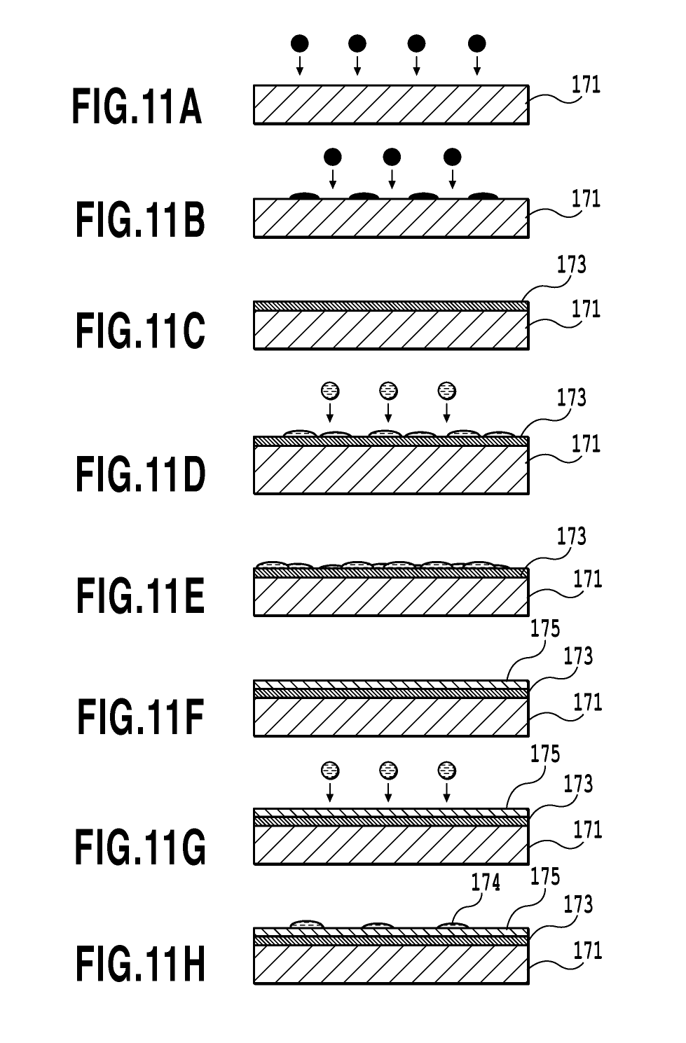

FIGS. 11A to 11H are cross sectional views for explaining the application of ink on a unit area of the print medium 171 by a multi-pass printing using the above described mask pattern. FIGS. 11A and 11B illustrate the gradual printing of color ink at passes 1 to 8. As a result of each of the 12.5% printings being carried out, as shown by FIG. 11C, a color ink layer 173 is formed on the print medium 171.

FIGS. 11D and 11E illustrate the 1st application step, where clear ink is gradually printed at passes 9 to 14. The successively printed clear ink drops connect when coming in contact with each other, forming the clear ink layer 175 on top of the color ink layer 173, as shown in FIG. 11F. Next, the clear ink layer 175 formed in this manner considerably fixes during pass 15 where the printing of clear ink is not carried out.

FIG. 11G illustrates the 2nd application step, where clear ink is printed at pass 16. Finally, 12.5% of printed clear ink is disposed such that adjacent ink drops do not come into contact with each other, and as shown in FIG. 11F, forms raised portions 174 on top of the already fixed clear ink layer 175.

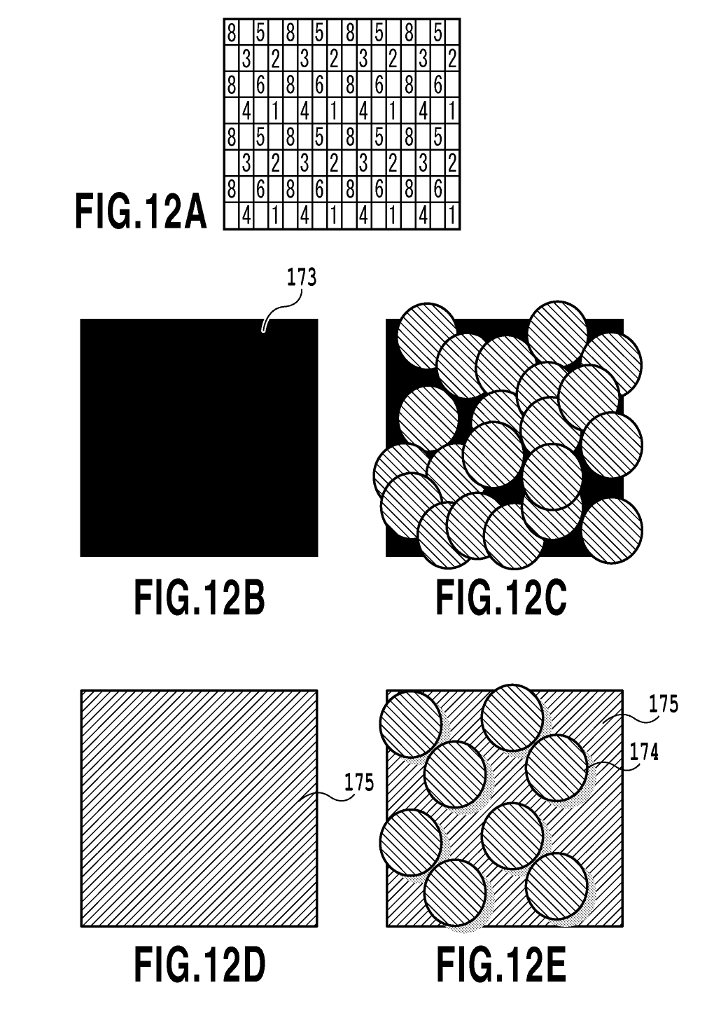

FIGS. 12A to 12E are schematic top views for explaining the above described printing state. FIG. 12A illustrates the order of the pixel positions where clear ink drops are printed on the unit area. That is, [1] is shown at the pixels where printing is carried out by the 1st clear ink pass (9th pass), [2] is shown at the pixels where printing is carried out by the 2nd pass (10th pass), and so on, and lastly [8] is shown at the pixels where printing is carried out by the 8th pass (16th pass).

FIG. 12B shows a state where printing of color ink at passes 1 to 8 have been completed, and a color ink layer 173 has been formed. FIG. 12C shows a state where clear ink is being gradually printed at the first application step on top of the color ink layer 173 formed as in FIG. 12B. As also shown in FIG. 10, the arrangement of the print-permitted pixels of the clear ink mask patterns used in the present embodiment is scattered. However, when clear ink is printed at adjacent positions by successive print scans multiple drops of clear ink contact one another and a layer of clear ink 175 with a uniform thickness is formed (FIG. 12D). Next, the clear ink layer 175 formed in this manner considerably fixes during pass 15 where the printing of clear ink is not carried out.

FIG. 12E illustrates a state where 12.5% of clear ink has been printed at the 2nd application step. As can be understood from FIG. 10, because the arrangement of print-permitted pixels of the mask pattern allocated to region 8 is dispersed, adjacent ink drops do not come into contact with each other, and the raised ink portions 174 are formed and fixed on top of the already fixed clear ink layer 175.

Above, a case was explained where clear ink was printed on top of the color ink layer 173, but it is not the case that image data exists at every area, and it is not the case that that color ink forms a layer at every area. White paper areas where color ink is not printed on the print medium and low gradation areas where only a small amount of color ink is printed both exist.

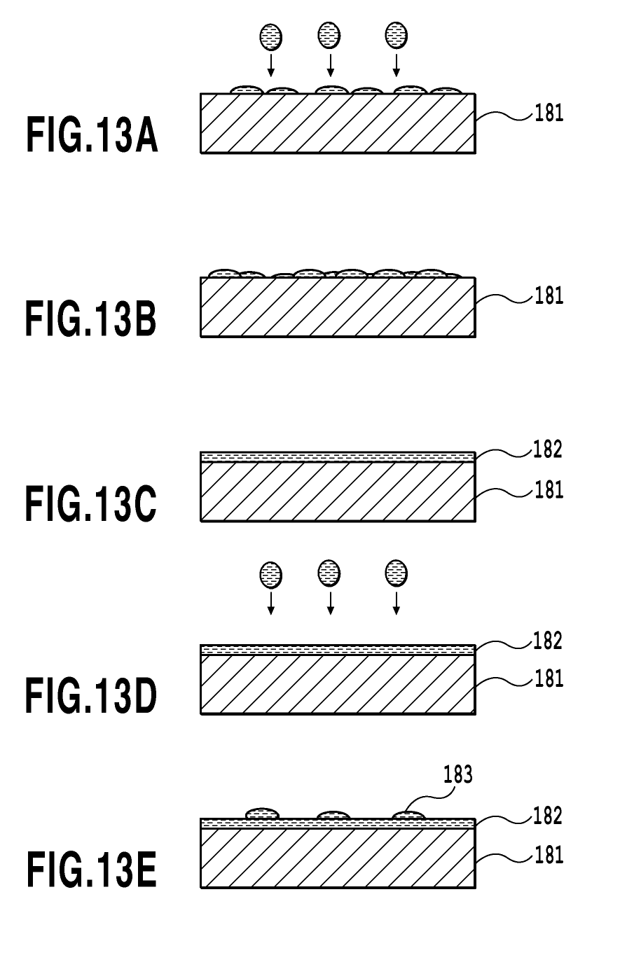

FIGS. 13A to 13E are cross sectional views for explaining the application of ink on a unit area of the print medium where image data does not exist, by a multi-pass printing using the above described mask pattern. At the areas where image data does not exist, because print data is not generated when a “logical AND” operation is carried out between the color mask patterns shown in FIG. 8 and the image data, the printing of color ink is not carried out at those areas at passes 1 to 8. However, the printing of clear ink is carried out at these areas at passes 9 to 16.

FIGS. 13A and 13B illustrate the 1st application step, where clear ink is gradually printed at passes 9 to 14 on the white paper print medium 181. As shown in FIG. 13C, a clear ink layer 182 is formed by the 1st application step, and it considerably fixes during pass 15 where the printing of clear ink is not carried out.

FIG. 13D illustrates the 2nd application step, where clear ink is printed at pass 16. The finally printed 12.5% of clear ink is disposed such that adjacent ink drops do not come into contact with each other, and as shown in FIG. 13E, forms raised portions 183 on top of the already fixed clear ink layer 182.

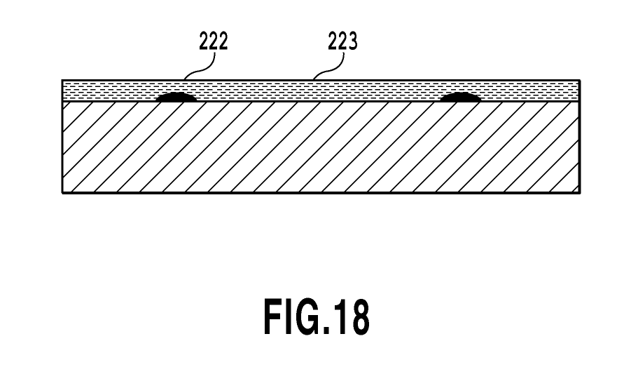

On the other hand, FIG. 18 is a cross sectional diagram for explaining the printing aspects of the 1st application step at a low gradient area. At the low gradient area, a color ink layer 173 such as those shown in FIGS. 11A to 11H are not formed because color ink is only dispersedly printed, and clear ink is printed on the raised portions of ink 222 that exist here and there. Even in the case where printing has been carried out as such, because the surface tension of the clear ink of the present embodiment is low it spreads easily on the print medium, and a clear ink layer 223, having a uniform thickness, is formed. Therefore, the clear ink printed at the 2nd application step, as shown in FIGS. 11A to 11H and FIGS. 13A to 13E, forms raised portions of ink and fixes on top of the uniform clear ink layer 223.

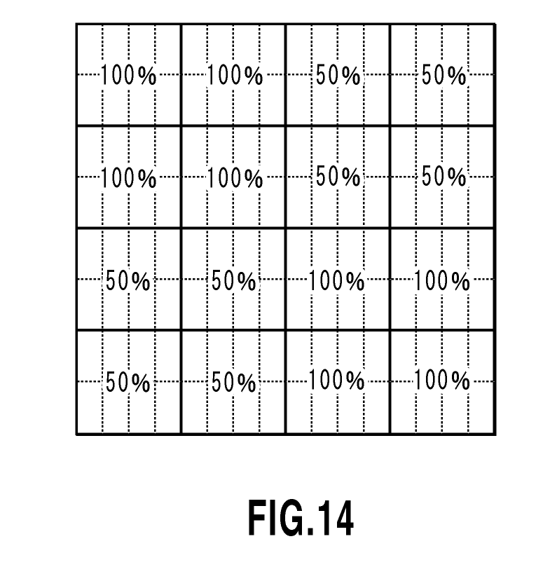

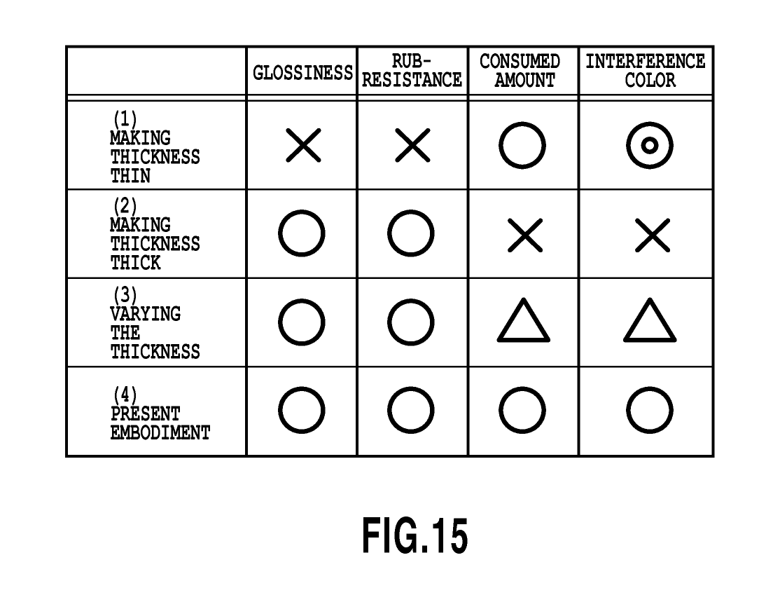

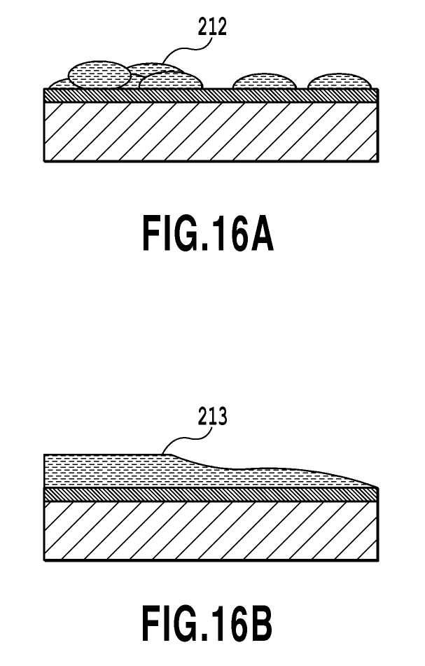

FIG. 15 is shows the result of comparing the case where methods (1) to (3) for restraining interference colors described in the Background of the Invention are used and the case of carrying out an overcoat by the method of the present embodiment, with respect to glossiness, scratch resistance, amount of clear ink consumed and conspicuousness of interference colors. As shown at (1), when the clear ink layer is extremely thin interference colors due to the clear ink and the consumption amount of clear ink are restrained, but the fundamental purposes of applying a clear ink, that is, glossiness and scratch resistance at the image surface, are not obtained. As shown at (2), when the clear ink layer is made thick, glossiness and scratch resistance, the fundamental advantages of applying a clear ink, improve, however, the interference colors due to the clear ink stand out, and the consumption amount of clear ink increases. As shown at 3, by biasing the print distribution rate, that is, by the method explained at FIG. 14 and FIGS. 16A and 16B, in the case of forming portions where the clear ink thickness is thick and thin, interference colors become more difficult to stand out and the consumption of clear ink is reduced in comparison to (2), however they remain unsatisfactory. In contrast, when the method of the present embodiment is employed, while realizing the fundamental advantages of applying clear ink, sufficient glossiness and scratch resistance at the image surface, it is also possible to sufficiently restrain interference colors and the consumption of clear ink.

As explained above, according to the present invention it is possible to divide the clear ink overcoat into a 1st application step and a second application step, by way of making one region of the print head of the multi-pass printing a non-printing region (region 7). That is, when performing multi-pass printing at a unit area on a print medium, at least one pass or more where clear ink is not applied is provided between the passes where clear ink is provided. Herewith, because time is provided where clear ink is not applied at the unit area, clear ink is applied at the second application step after the clear ink applied at the first application step has fixed. By way of employing such a configuration, at both image areas, where color ink is printed and white paper areas where color ink is not printed, it is possible to cause various wavelengths (colors) of light to be included in the reflected light in the same way, and it is possible to output printed matter wherein a particular interference color can not be visually perceived when viewed.

### Second Embodiment

As is the case with the 1st embodiment, the printing apparatus shown in FIG. 2 and FIG. 3 is also used in the present embodiment. However, in the present embodiment the clear ink ejection port array is not shifted in the sub-scanning direction with respect to the color ink and is lined up in the main-scanning direction.

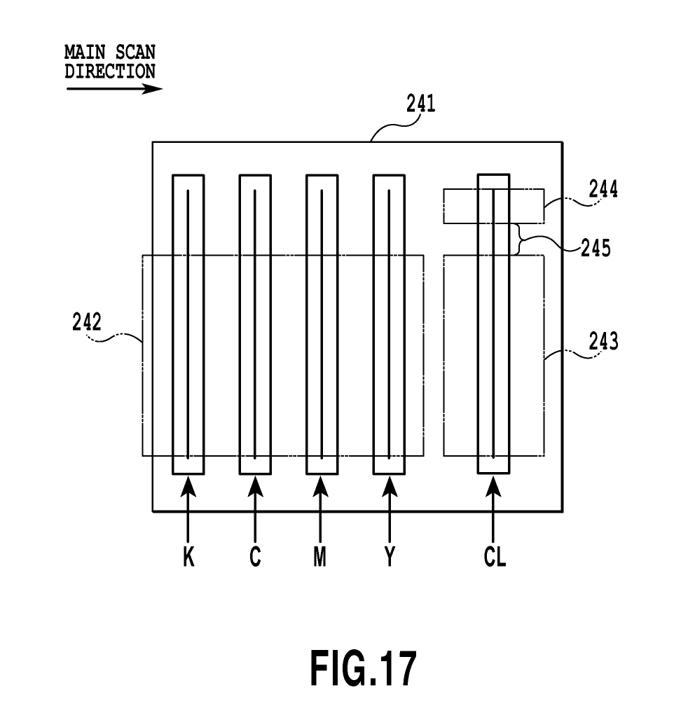

FIG. 17 is a schematic diagram that illustrates the configuration of the ejection port surface of the print head 241 used in the present embodiment. In the same manner as the first embodiment, ejection port arrays of 1 color, consisting of 1280 ejection ports aligned in the sub-scanning direction at a density of 1200 dots per inch, are formed on the print head 241, and a number of arrays corresponding to the ink colors are plurally aligned in the main scanning direction. In the present embodiment, black ink K, cyan ink C, magenta ink M, yellow ink Y and clear ink 4CL ejection port arrays are, without being shifted from each other in the sub-scanning direction, lined up in the main scanning direction in the order of the figure. The printing apparatus of the present embodiment makes use of this type of print head 241 and performs 8-pass multi-pass printing.

In the present embodiment in order to establish a 1st clear ink application step and a 2nd clear ink application step, the regions of the color ink ejection port array that are used for printing are limited. Concretely, only the ejection ports included in region 242 are used to carry out printing, and ejection ports included in regions other than this are not used to carry out printing. Once again referring to FIG. 9, this type of printing is implemented by the use of a mask pattern having print-permission ratios of approximately 16.7% at regions 1 to 6 and 0% and regions 7 and 8. On the other hand, with respect to the clear ink, printing is carried out at the ejection ports included in the region 243 and the region 244, and the ejection ports included in region 245 do not perform printing. This type of printing is implemented by using the mask patterns shown in FIG. 10.

In the case of the present embodiment, clear ink of the 1st application step is printed at the same print scans as the color ink. In other words, the 1st clear ink application step is performed during the color ink printing step. Therefore, in the multi-pass printing, portions where clear ink is printed after color ink has been printed and portions where color ink is printed after clear ink has been printed are mixed on the print medium. However, because an amount of the low surface tension clear ink drops sufficient for them to connect to each other and form a layer are printed, at the first application step it is possible to form a smooth layer of clear ink similar to that of the 1st embodiment. Thus, it is possible to output printed matter wherein particular interference colors are not visually perceived upon observation, due to the raised portions of clear ink that are formed by the 2nd application step which is performed after the clear ink layer formed in that way has fixed.

### Third Embodiment

As is the case with the 1st embodiment, the printing apparatus shown in FIG. 2 and FIG. 3 is also used in the present embodiment. Also, with respect to the print head, the same print head as that of the 2nd embodiment is used. However, in the present embodiment, non-printing regions are not provided on the color ink ejection port arrays, and printing is performed at all of the regions.

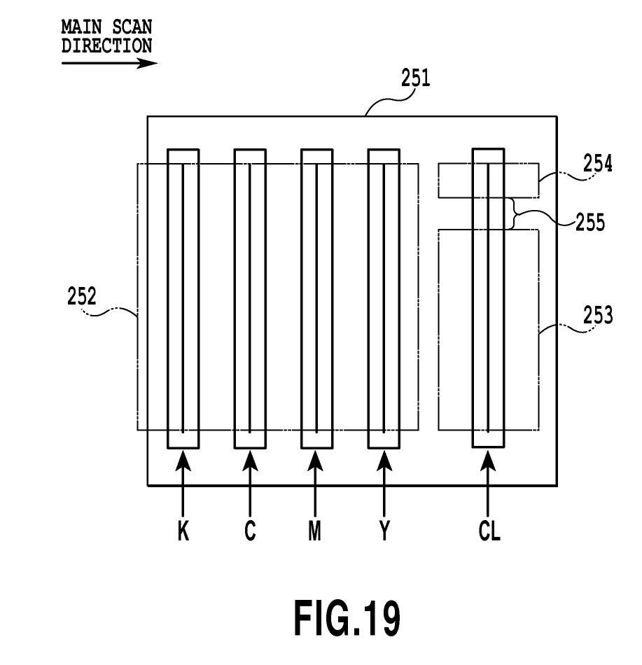

FIG. 19 is a schematic diagram of the configuration of the ejection port surface of the print head 251 used in the present embodiment. The arrangement of each of ejection port arrays is the same as that of FIG. 17 explained at the 2nd embodiment. However, in the present embodiment, with respect to color ink, printing is performed using all of the ejection ports included in the region 252.

In the present embodiment in order to establish a 1st clear ink application step and a 2nd clear ink application step, after completing color ink multi-pass printing, the clear ink application step is executed after the print medium is fed back.

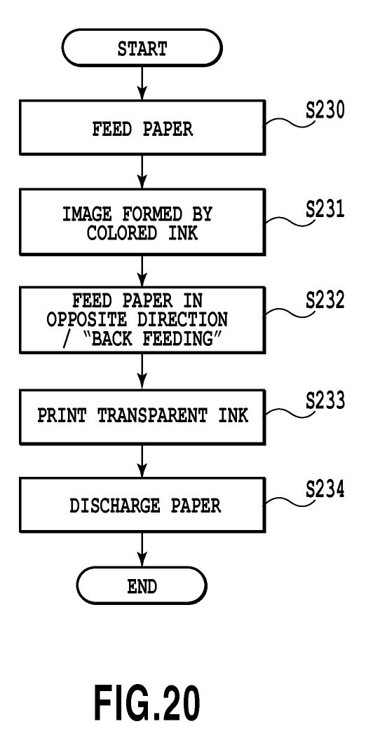

FIG. 20 is a flowchart for explaining the printing steps executed by the system controller 301 of the present embodiment. When a print command is input from the host computer 306, the system controller 301 first, at step S230, feeds a single sheet of the print media stacked in the print tray 15 into the inner portion of the apparatus. Next, at step S231, 8-pass multi-pass printing is performed in accordance with the input image data, using the complete color ink ejection port region 252. At this time, the printing of clear ink is not performed.

When the printing has been completed in accordance with the image data, the system controller 301 rotates the conveyance motor in the reverse direction and feeds the print medium back. Next, at step 233, an 8-pass multi-pass printing of clear ink is performed. Because the clear ink ejection port array uses the mask patterns shown in FIG. 10, a 1st application step is performed by region 253 (regions 1 to 6), a non-printing scan is performed, for fixation, at region 255 (region 7), and a 2nd application step is performed by region 254 (region 8). When this type of clear ink application step is completed, proceeding to step 234, the print medium is discharged outside of the apparatus. With that the present process is completed. According to the present embodiment explained above, it is possible to obtain a printed object with the same laminar structure as that of the 1st embodiment. That is, at both image areas where color ink is printed and white paper areas where color ink is not printed, it is possible to cause various wavelengths (colors) of light to be included in the reflected light in the same way, and it is possible to output printed matter wherein a particular interference color can not be visually perceived when viewed.

### Other Embodiments

In the embodiment explained above, in an 8-pass multi-pass printing only the 7th pass (region 7), that is, only 1 scan (region) was a scan in which clear ink was not printed, however, the present invention is not limited as such. In the case where a longer time is needed for fixation, the clear ink non-printing scan may be made N (N is an integer equal to or greater to 1) scans, of 2 or more consecutive scans, suited to this time. Also, print scans for the 2nd application step are also not limited to 1 scan units. For example, referring again to FIG. 10, if the print permission ratios of regions 5 and 6 are set to 0%, and the print permission rations of regions 7 and 8 are not set to 0%, it is possible to make the printing from region 1 to region 4 the 1st application step and the printing at regions 7 and 8 the 2nd application step.

Also, the present invention is not limited to the construction performing multi-pass printing. The present invention can be applied to the 1-pass printing. Even if the 1-pass printing, the first application step and the second application step for applying the clear ink may be prepared. Additionally, a fixation time for fixing the clear ink applied in the first application step may be prepared between them. In this case it is not necessary to provide print scans without application of ink. That is, a configuration is also acceptable wherein the print head is made to wait without scanning. In this case, it is necessary to provide amount of non ink application time that is at least as long as, or longer, than the amount of time necessary for the print head to make 1 printing pass. For example, if the time necessary for 1 printing pass is taken to be approximately 3 seconds in the present embodiment, a waiting time of at least 3 seconds or more may be provided. Furthermore, in order to improve throughput, it is preferable not to provide more than an amount of time equivalent to 5 passes; for example, in the present embodiment it would be preferable to provide 15 seconds or less.

It is also possible that the fixation time of the clear ink applied by the first application step is set to a time until a flowability of the clear ink is come down to a extent. In other ward, the fixation time may be a time until the clear ink applied by the first application step is fixed enough that the clear ink applied by the second application step is not mixed with the clear ink applied by the first application step and the surface does not become flat.

Furthermore, in the above embodiments, an example of a serial type ink jet printing apparatus that forms images by alternating print head scans and print medium conveyance operations was explained, however, the present invention is not limited to this configuration. The present invention is characterized in that the printing of clear ink to overcoat the printed matter is split into a 1st application step for forming a clear ink layer and a 2nd application step for forming raised portions on the formed clear ink layer. Therefore the present invention can also be advantageously applied to a so-called full-line type printing apparatus in which the print medium is conveyed at a set speed with respect to a fixed print head having an ejection port array corresponding to the width of the print medium. In the case of a full-line type printing apparatus, for example, after carrying out the 1st application step by a clear ink ejection port array, the print medium may be fed back and a 2nd application step may be executed.

Furthermore, in the above embodiments a clear n amount for forming a sufficiently thick layer is printed, and there is no need to use larger amount of clear ink than necessary. Therefore it is desirable that the clear ink print ratio is adjusted to an appropriate value in accordance with the amount of ink drops ejected from the individual ejection ports (ejection volume), the printing resolution of the printing apparatus and the type of print medium, regardless of whether it is equal to or greater than 50% or lower than 50%.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-042704, filed Feb. 26, 2010, which is hereby incorporated by reference herein in its entirety.

What is claimed is:

1. An ink jet printing method comprising:
a printing step wherein an image is printed on a unit area of the print medium by application of color ink containing color material from an application unit;
a first application step wherein clear ink not containing color material is applied by the application unit onto the unit area during said printing step or after said printing step is completed; and
a second application step which is performed after said first application step has been completed, wherein the clear ink is applied at the unit area by the application unit, after taking time for the fixation of the clear ink applied at said first application step.

2. An ink jet printing method according to claim 1 wherein at said second application step the application unit applies an amount of the clear ink less than that of said first application step.

3. An ink jet printing method according to claim 1, wherein the application unit is provided with an ejection port array that ejects the color ink and an ejection port array that ejects the clear ink, and the image is completed by the application unit performing a plurality of relative scans with respect to the unit area of the print medium, and
wherein at said second application step, after performing N (an integer equal or greater to 1) scans of the relative scan without the application of the clear ink, the application unit performs the relative scan with the application of the clear ink, at the unit area completed by said first application step.

4. An ink jet printing method according to claim 3 wherein the application unit performs the relative scan by moving in a direction that crosses a conveyance direction of the print medium, and wherein on the application unit at least one portion of the clear ink ejection port array is arranged on a more downstream side of the conveyance direction than the color ink ejection port array.

5. An ink jet printing method according to claim 3 wherein said first application step is performed at the same the relative scan as said printing step.

6. An ink jet printing method according to claim 3 wherein said first application step is performed at the unit area completed by said printing step, after the print medium feed back has been performed.

7. An ink jet printing method according to claim 1 wherein the color ink includes pigment as the color material.

8. An ink jet printing apparatus comprising:
an application unit capable of applying color ink containing color material and clear ink not containing color material;
a control unit configured to control said application unit;
wherein said control unit controls said application unit such that an image is printed on a unit area of the print medium by the application of the color ink from said application unit,
the clear ink is applied on the unit area during the application of the color ink or after the completion of the application of the color ink by said application unit, and
after the application of clear ink has been completed and after taking fixation time for the fixation of the applied clear ink, the clear ink is applied at the unit area again.

9. An ink jet printing apparatus according to claim 8, wherein the amount of the clear ink applied by said application unit after the fixing time is less than the amount of the clear ink applied before the fixing time.

10. An ink jet printing apparatus according to claim 8, wherein said application unit is provided with an ejection port array that ejects the color ink and an ejection port array that ejects the clear ink, and the image at the unit area is completed by said control unit causing a relative scan of said application unit with respect to the print medium, and
wherein the fixing time is a time for performing N (an integer equal or greater to 1) scans without the application of the clear ink at the unit area completed by the application of the clear ink before the fixing time.
